(19) United States
(12) Patent Application Publication
(10) Pub. No.: US 2014/0372194 A1
(43) Pub. Date: Dec. 18, 2014

(54) EVENT SALE SYSTEM USING SOCIAL AUCTION AND METHOD THEREOF

(71) Applicant: Ki-Won Nam, Seoul (KR)

(72) Inventor: Ki-Won Nam, Seoul (KR)

(21) Appl. No.: 14/372,745

(22) PCT Filed: Jan. 17, 2013
(86) PCT No.: PCT/KR2013/000372

§ 371 Date: Jul. 16, 2014

(30) Foreign Application Priority Data
Jan. 17, 2012 (KR) 10-2012-0005034
Jul. 20, 2012 (KR) 10-2012-0079619

(51) Int. Cl. G06Q 30/02; G06Q 50/00; G06Q 30/08

(52) U.S. Cl. CPC G06Q 30/0222; G06Q 30/08; G06Q 30/0241; G06Q 50/01
USPC 705/14.23

(57) ABSTRACT

Disclosed are an event sale system using a social auction and a method thereof capable of providing a balanced discount between sellers and purchasers by allowing the reserved purchasers to competitively select and determine a discount rate on their own until a predetermined accumulated discount rate is completely exhausted and the sellers to perform discount processing on the determined discount rate, and strengthening competitiveness using marketing tools differentiated due to various conditions further set by each seller.

### BACKGROUND OF THE INVENTION

1. Field of the Invention

The present invention relates to an event sale system using a social auction and a method thereof, and more particularly, to an event sale system using a social auction and a method thereof capable of providing a balanced discount between sellers and purchasers by allowing the reserved purchasers to competitively select and determine a discount rate on their own until a predetermined accumulated discount rate is completely exhausted and the sellers to perform discount processing on the determined discount rate, and strengthening competitiveness using marketing tools differentiated due to various conditions further set by each seller.

2. Description of Related Art

As known, with the recent development of information communication technologies, a development of information providing technologies which provide information on various fields to multiple subscribers through at least one host server via a wide area data communication network in real time has been actively conducted.

Based on the technologies, recently, a peripheral technology, such as a cache memory extension technology for more rapidly providing accurate information to subscribers and an information selection technology and a compression technology providing a more convenient access to taste and preference of subscribers are being developed. Further, these technologies have given impetus to the development of various contents and a solution thereof.

Meanwhile, domestic and foreign online markets are rapidly growing, in which the online market may be largely divided into an online advertising market and an online shopping market. The on-line advertising market finally relates to advertisement for a company or a product, and therefore is indirectly associated with a shopping market and is classified into a pure on-line advertising market and a shopping market.

The marketing in the on-line advertising market is mainly performed by two ways, such as how many customers the corresponding advertisement is exposed to, and how many valid customers advertisement is effectively exposed to.

Therefore, the online advertising market and shopping market are to expose advertisement or shopping information to more customers and sell goods to customers. To this end, various advertising methods or shopping activation methods have emerged.

The advertising technique or the shopping activation technique is to provide predetermined saved money to customers reading advertisement or purchasing goods to make customers read more advertisements and purchase more goods.

However, the traditional technique is not attractive to customers since saved money provided to each customer is very significant, and therefore is not helpful for marketing or shopping activation of a seller.

Therefore, the traditional advertising technique may not effectively perform the promotion or sales of goods even though sellers spend much promotion cost to promote or sell goods.

Recently, an open market which may allow various sellers to freely sell goods on one site has emerged. The open market is a market which may allow various sellers to upload and sell their own goods and execute settlement for the goods, promotion of the corresponding open market, and the like for an open market operator to execute a portion of businesses to be executed by sellers, thereby more conveniently selling goods.

However, the number of open markets tends to be increased, and thus inter-open market competition may be inevitable. As a result, a sale of sellers belonging to the open market which loses competition is reduced, and therefore the open market operators need to have strong promotion means.

### SUMMARY OF THE INVENTION

An object of the present invention is to provide an event sale system using a social auction and a method thereof which may provide a balanced discount between sellers and purchasers by allowing the reserved purchasers to competitively select and determine a discount rate on their own until a predetermined accumulated discount rate is completely exhausted and the sellers to perform discount processing on the determined discount rate, and strengthen competitiveness using marketing tools differentiated due to various conditions further set by each seller.

Another object of the present invention is to provide an event sale system using a social auction and a method thereof which may accept a social auction participating signal of purchasers on goods output from the corresponding advertisement, interworking with advertisement output through TV, and provide purchase support money of the corresponding goods to maximize an advertising effect.

Still another object of the present invention is to provide an event sale system using a social auction and a method which, when an equivalent value of free purchasing tickets owned by purchasers is smaller than an available amount of permitted free purchasing tickets, and thus the difference pays in a cash or a credit card, may provide a right to participate in a social auction using the difference and convert the difference into saved money.

In order to accomplish the above objects, there is provided an event sale system using a social auction, including: a purchaser terminal configured to purchase a brand purchasing ticket for participating in an auction supported with a discount rate using a future purchase of goods as security, and generate an auction participating signal; a seller terminal configured to perform an issuance request issuing the brand purchasing ticket securing a future sale to a purchaser, registration of sale goods information, and registration of sale conditions, and generate a signal providing a predetermined number of goods to be used as promotion resources; and a social auction service operating server configured to sell the brand purchasing tickets issued to each seller as a social auction participating condition, register purchaser information, and perform auction processing using sale cost of the brand purchasing ticket and goods for promotion as resources.

Preferably, the social auction automatically increases a discount rate for a predetermined time period from an auction starting time until a preset accumulated discount rate is completely exhausted, and reserved purchasers select a specific discount rate on their own, and thus a plurality of purchasers are selected as a support recipient and receive support money corresponding to a discount rate.

Preferably, the brand purchasing ticket includes: a goods designated brand purchasing ticket promising a future purchase of specific goods of a specific brand; and a goods non-designated brand purchasing ticket promising a future purchase of the specific brand but not promising a purchase of specific goods.

Preferably, the social auction service operating server performs processing to subtract a discount rate of 100% corresponding to a discount rate of one goods, when a selection signal of reserved purchasers for a specific discount rate is generated at the time of progressing an auction in the case in which a seller provides goods for promotion.

Preferably, the social auction service operating server automatically informs reserved purchasers purchasing brand purchasing ticket issued by corresponding companies of social auction starting information, when social auction starting conditions of each company are satisfied.

Preferably, the social auction service operating server determines whether non-suggested residual goods are present, when successful bidding processing is made by generating a selection signal of reserved purchasers for a specific discount rate at the time of progressing an auction in the case in which a purchaser provides goods for promotion, and if it is determined that the non-suggested residual goods are present, performs an additional social auction.

Preferably, the social auction service operating server preferentially processes subtraction processing on goods when a successful bidder is generated due to the progress of the auction in the case in which a seller provides goods and issuance resources of the brand purchasing tickets for promotion, and when residual goods are not present, performs successful bidding processing in order of subtraction processing on the issuance resources of the brand purchasing ticket.

Preferably, the social auction service operating server further stores a special condition of a seller for the use of the corresponding purchasing ticket matched with a unique number of the corresponding purchasing ticket in the case of the goods non-designated brand purchasing ticket.

Preferably, the social auction service operating server stores a set condition to change a sale condition set by the seller corresponding to an accumulated issuance number at the time of issuing the brand purchasing ticket and monitors the issuance number to automatically change the sale condition.

Preferably, the social auction service operating server stores a set condition of a purchaser to automatically change purchasable goods depending on a successful bidding discount rate when a social auction is completed and automatically changes the set condition.

Preferably, the social auction service operating server performs processing to participate in an auction only in the case in which the corresponding brand purchasing ticket has a higher issuance face value than that of brand purchasing tickets of other brand companies by using the brand purchasing ticket, when a reserved purchaser participating in the social auction of other brands is present.

Preferably, the social auction service operating server performs processing to change an auction type at the time of consent of a predetermined ratio of participating purchasers when an accumulated discount rate into which the promotion resources are converted is smaller than a set value.

Preferably, the social auction service operating server sets a predetermined number of specific goods matched with goods output through TV advertisement or specific goods matched with the corresponding goods as an event resource to progress a TV advertisement interworking social auction service for a period at which the corresponding TV advertisement is output.

Preferably, the social auction service operating server transmits a residual time of auction service participation and goods information to be auctioned matched with the corresponding TV advertisement as information on the TV advertisement interworking social auction service.

Preferably, the social auction service operating server accepts requested discount rate information from the purchaser terminal from starting of the TV advertisement interworking social auction service until auction participating residual time arrives.

Preferably, the social auction service operating server include: a communication module configured to communicate with the purchaser terminal and the seller terminal; a membership information management unit configured to manage personal information on a purchaser and a seller; a purchasing ticket issuance information management unit configured to manage purchasing ticket issuance information; a TV advertisement schedule management unit configured to manage TV advertising schedule information to progress a social auction matched with the TV advertisement; a TV advertisement information interworking processing unit configured to process goods information interworking with the TV advertisement, promotion information of the corresponding goods, and auction time information to progress the social auction matched with the TV advertisement; a discount rate auction processing unit configured to accept the requested discount rate of a plurality of purchasers, and perform subtraction processing on purchasing support money by subtracting the requested discount rate from accumulated promotion cost; a data storage unit configured to store purchasing ticket issuance information, goods information interworking with the TV advertisement to progress the social auction matched with the TV advertisement, promotion information of the corresponding goods, auction time information, and auction result information; and a control unit configured to transmit the social auction information progressed interworking with the TV advertisement to the purchaser terminal to accept auction participation, and process the social auction to perform a control for informing the goods information of the seller progressing the TV advertisement.

Preferably, the TV advertisement interworking social auction service accepts the social auction for specific goods set by a seller of the corresponding TV advertisement for a period at which the specific TV advertisement is output, and is set in the social auction service operating server to select the predetermined number of purchasers which receive the purchase support money.

Preferably, the TV advertisement interworking social auction service divides the time when the specific TV advertisement is output into multi sections, accepts the social auction for specific goods set by a seller of the corresponding TV advertisement at each section, and is set in the social auction service operating server to select the predetermined number of purchasers which receive the purchase support money at each section.

Preferably, accumulated promotion cost set in the corresponding goods is processed by the social auction service operating sever to be equally divided at each section

Preferably, since an equivalent value of a free purchasing ticket owned by a purchaser is smaller than a use amount of the free purchasing ticket permitted to specific goods, when the difference is settled in cash or credit card, the social auction service operating server provides a right to participate in a social auction using the difference or convert the difference into saved money.

Preferably, the free purchasing ticket allows the purchaser to receive a discount service of an amount corresponding to a free purchasing ticket selling amount by an engagement of sellers.

Preferably, the social auction service operating server includes: a membership information management unit configured to manage information on a seller and a purchaser; a purchasing ticket issuance information management unit configured to manage purchasing ticket issuance information; a sale condition management unit configured to manage sale condition information uploaded by each seller; a goods information management unit configured to manage sale information to be sold by the seller; a discount rate auction processing unit configured to accept a requested discount rate of a plurality of purchasers and performing subtraction processing on purchasing support money by subtracting the requested discount rate from accumulated promotion cost; a settlement difference conversion unit configured to convert a difference settled in cash or credit card into a social auction participating ticket or saved money since an equivalent value of the free purchasing ticket owned by the purchaser is smaller than a use amount of a free purchasing ticket permitted to specific goods; a data storage unit configured to store issuance information on the free purchasing ticket, and available amount information of the free purchasing tickets for each seller, and store cash settlement difference information at the time of using the free purchasing ticket, and compensation information on the difference; and a control unit configured to perform a control to manage the issuance information on the free purchasing ticket, manage the available amount information on the free purchasing tickets for each seller, and convert the cash settlement difference at the time of using the free purchasing ticket.

Preferably, the social auction service operating server further includes a seller information arrangement unit configured to arrange the seller information in order of a large available amount permitting the use of the free purchasing ticket having a larger equivalent value, arrange the seller information in order of a large event amount in the seller information holding special event information, or arrange the seller information included in a specific area to be read by the purchaser terminal.

According to another aspect of the present invention, there is provided an event sale method using a social auction, including: a first process of setting, by a social auction service operating server, a predetermined number of goods as promotion resources from a seller terminal; a second process of converting the corresponding promotion goods into accumulated saved money; a third process of determining, the social auction service operating server, whether a social auction condition is satisfied; a fourth process of performing processing to automatically increase a discount rate at the same ratio at a predetermined period from starting of an auction until a preset accumulated discount rate is completely exhausted; a fifth process of processing a corresponding selected purchaser as a successful bidder by receiving a selection signal for a specific discount rate from a reserved purchaser terminal; a sixth process of subtracting 100% regardless of the selected discount rate; a seventh process of determining whether a residual accumulated saved money is present; an eighth process of settling a final settlement amount of each successful bidder; and a ninth process of performing settlement processing.

Preferably, the third process further includes informing all the reserved purchasers that all the reserved purchasers participate in the social auction without condition.

Preferably, the fourth process includes: dividing a total accumulated saved money several times; monitoring whether the accumulated saved money is completely exhausted due to the progress of the auction; and additionally suggesting the divided accumulated save money every time the accumulated saved money is completely exhausted.

Preferably, when the promotion resources suggested by the seller in the first process are goods and a brand purchasing ticket issuance income, subtraction of the accumulated saved money for goods is preferentially processed at the time of processing the successful bidding, and when the accumulated saved money for goods is completely exhausted, the subtraction processing is performed in subtraction order of the accumulated saved money into which the brand purchasing ticket issuance income is converted.

Preferably, the ninth process further includes determining whether the settlement of the purchaser satisfies a special condition of the seller for the use of the corresponding purchasing ticket, when the brand purchasing ticket purchased by the purchaser is a goods non-designated brand purchasing ticket at the time of settlement.

Preferably, the event sale method further including: prior to the first process, storing a set condition to change a sale condition set by the seller in response to the accumulated issuance number at the time of issuing the brand purchasing ticket; monitoring the issuance number of the brand purchasing ticket issued by the corresponding seller; and automatically changing the sale condition by reflecting the preset sale condition of the corresponding seller.

Preferably, the eighth process further includes: determining whether purchasable goods information depending on the successful bidding discount rate is present when the social auction is completed; and when the purchasable goods depending on the corresponding successful bidding discount rate are present, suggesting purchasable information by being automatically changed to the corresponding goods information.

According to another aspect of the present invention, there is provided an event sale method using a social auction, including: a first process of providing a social auction resource to a social auction service operating server due to an issuance of a brand purchasing ticket of a seller; a second process of determining whether a desired participating signal is applied to another brand social auction; a third process of determining whether a face value of the corresponding brand purchasing ticket is equal to or larger than that of another brand purchasing ticket to participate; a fourth process of performing auction participating possible processing when a face value of the corresponding brand purchasing ticket is equal to or larger than that of another brand purchasing ticket to participate; and a fifth process of performing processing to include a corresponding difference in an accumulated saved money resource when the face value difference is present.

According to another aspect of the present invention, there is provided an event sale method using a social auction, including: a first process of determining, by a social auction service operating server, whether an auction type changing request signal is accepted during a progress of the social auction; a second process of determining, by the social auction service operating server, whether there is a condition to change the auction type; if it is determined that the auction type is changed, a third process of publicly announcing, by the social auction service operating server, the auction type change to a corresponding auction participant; and a fourth process of performing processing to change the auction type at the time of consent of a predetermined ratio of participating purchasers.

Preferably, the condition to change the auction type in the second process is on whether the residual accumulated saved money is equal to or less than a predetermined amount.

### BRIEF DESCRIPTION OF THE DRAWINGS

FIG. 1 is a diagram illustrating a schematic configuration of an event sale system using a social auction according to an embodiment of the present invention.

FIG. 2 is a block configuration diagram illustrating a configuration of a social auction service operating server included in an event sale system using a social auction according to a first embodiment of the present invention.

FIG. 3 is a diagram schematically illustrating an operating principle of the event sale system using a social auction according to the first embodiment of the present invention.

FIG. 4 is a flow chart illustrating a signal flow of the event sale system using a social auction according to the first embodiment of the present invention.

FIG. 5 is a flow chart illustrating a signal flow for an automatic product suggest of the event sale system using a social auction according to a first embodiment of the present invention.

FIG. 6 is a flow chart illustrating a signal flow for a social auction using, as resources, a product and accumulated saved money of an event sale system using a social auction according to a second embodiment of the present invention.

FIG. 7 is a flow chart illustrating a signal flow for a brand purchasing ticket use of an event sale system using a social auction according to a third embodiment of the present invention.

FIG. 8 is a flow chart illustrating a signal flow for registration of goods non-designated brand purchasing ticket of the event sale system using a social auction according to the third embodiment of the present invention.

FIG. 9 is a flow chart of a signal flow for a fluctuation of bidding discount rate interworking transaction conditions of an event sale system using a social auction according to a fourth embodiment of the present invention.

FIG. 10 is a flow chart illustrating a signal flow for a brand purchasing ticket cross use of an event sale system using a social auction according to a fifth embodiment of the present invention.

FIG. 11 is a flow chart illustrating a signal flow for a change in an auction based on swarm intelligence of an event sale system using a social auction according to a sixth embodiment of the present invention.

FIG. 12 is a diagram illustrating a schematic configuration of an event sale system using a social auction according to a seventh embodiment of the present invention.

FIG. 13 is a diagram illustrating an information output state of a TV interworking social auction using the event sale system using a social auction according to the seventh embodiment of the present invention.

FIG. 14 is a block configuration diagram illustrating a configuration of a social auction service operating server included in the event sale system using a social auction according to the seventh embodiment of the present invention.

FIG. 15 is a diagram illustrating a state of processing a TV interworking social auction in real time using the event sale system using a social auction according to the seventh embodiment of the present invention.

FIG. 16 is a block configuration diagram illustrating a configuration of a social auction service operating server performing purchasing ticket settlement difference conversion processing using an event sale system using a social auction according to an eighth embodiment of the present invention.

FIG. 17 is a diagram illustrating the purchasing ticket settlement difference conversion processing state using an event sale system using a social auction according to the eighth embodiment of the present invention.

### DESCRIPTION OF SPECIFIC EMBODIMENTS

Hereinafter, embodiments of the present will be described in detail with reference to the accompanying drawings.

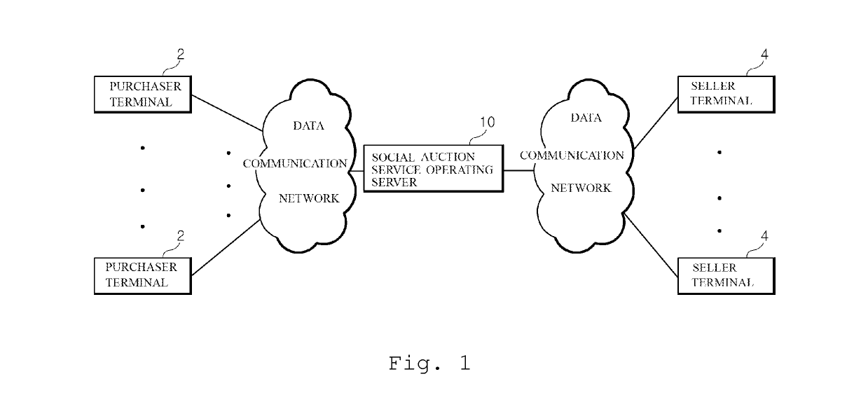

FIG. 1 is a diagram illustrating a schematic configuration of an event sale system using a social auction according to an embodiment of the present invention.

Referring to FIG. 1, the event sale system using a social auction is a system capable of providing a balanced discount between sellers and purchasers by allowing the reserved purchasers to competitively select and determine a discount rate on their own until a predetermined accumulated discount rate is completely exhausted and the sellers to perform discount processing on the determined discount rate, and strengthening competitiveness using marketing tools differentiated due to various conditions further set by each seller.

That is, the event sale system using a social auction according to an embodiment of the present invention is basically based on a social auction which induces inter-purchaser competition while allowing purchasers to determine a discount rate on their own so as to mutual restrain an acquisition of a discount rate over a predetermined level, thereby providing a sufficient merit for shopping to purchasers and allows sellers to secure purchasers using relatively smaller promotion cost, as well as a system which may assign more variously conditions to the sellers to provide sale environment customized for each seller.

In more detail, the event sale system using a social auction according to the embodiment of the present invention includes a purchaser terminal 2 which purchases a brand purchasing ticket for participating in an auction supported with a discount rate using a future purchase of goods as security and generates an auction participating signal.

Further, the event sale system using a social auction according to the embodiment of the present invention includes a seller terminal 4 which performs an issuance request to issue the brand purchasing tickets securing a future sale to purchasers, registration of sale goods information, and registration of sale conditions and generates a signal providing a predetermined number of goods to be used as promotion resources.

Meanwhile, the event sale system using a social auction according to the embodiment of the present invention includes a social auction service operating server 10 which sells the brand purchasing tickets issued to each seller as a social auction participating condition, registers purchaser information, and performs auction processing using sale cost of the brand purchasing tickets and goods for promotion as resources.

As described above, a purpose of the event sale system using a social auction according to the embodiment of the present invention is to activate a sale based on the social auction and impart a right to determine a discount rate to purchasers depending on their own selection.

Meanwhile, the social auction converts accumulated resources into a discount rate, increases the discount rate every predetermined time (for example, every 1 sec) when an auction starts, and when any purchaser selects the increasing predetermined discount rate, allows the purchasers selecting the discount rate as a successful bidder, and thus stops auction participation of the corresponding purchasers, but allows purchasers who do not yet generate a selection signal to have opportunity of selection.

That is, the event sale system using a social auction according to the embodiment of the present invention may make the purchasers set a discount rate assigned for a future purchase of goods on their own. In summary, in the event sale system using a social auction according to the embodiment of the present invention, a number of successful bidders are present in a single social auction.

Simply describing, the event sale system using a social auction according to the embodiment of the present invention seems like unilaterally providing great benefits only to the purchasers. However, since the accumulated discount rate is actually set constantly and a considerable number of purchasers are waiting to select, even though a considerable amount of accumulated discount rate remains, the accumulated discount rate may be exhausted at once.

Therefore, the event sale system using a social auction according to the embodiment of the present invention induces inter-purchaser competition to be difficult for purchasers to receive a discount rate over a predetermined level, and therefore searches for a balance for purchasers and sellers to receive a predetermined level of desired discount rate.

However, the event sale system using a social auction according to the embodiment of the present invention imparts an opportunity to receive a large discount rate to purchasers to induce the participation of purchasers, thereby activating a sale.

In this case, a resource of accumulated saved money may be prepared by allowing sellers to issue brand purchasing tickets which are social auction participating tickets or resources may be prepared by allowing sellers to provide specific goods as a predetermined number of promotions and these two resources may also be prepared by a combination thereof.

First, the brand purchasing ticket is a purchasing ticket which performs a participating ticket function to participate in a social auction and purchase goods of a specific brand, and becomes a resource which has a specific face value and is obtained by accumulating the face value in the accumulated discount rate. However, purchasers select a discount rate selected at the time of progressing a social auction as a discount rate higher than a face value of a brand purchasing ticket, and therefore there is no risk of the purchasers.

The brand purchasing ticket is classified depending on whether goods to be purchased in advance as a goods designated brand purchasing ticket and a goods non-designated brand purchasing ticket are designated. Herein, the goods designated brand purchasing ticket and the goods non-designated brand purchasing ticket have a difference in benefits, which will be described below in detail.

Further, other resources relate to a case in which sellers provide a predetermined number of specific goods for promotion. In this case, even the reserved purchasers which do not purchase a separate brand purchasing ticket may participate in a social auction, and other sources are very effective to allow purchasers to experience a social auction.

When sellers provide a predetermined number of specific goods for promotion, the social auction service operating server included in the event sale system using a social auction according to the embodiment of the present invention performs processing to subtract a discount rate of 100% corresponding to a discount rate of one product when discount selection signals of reserved purchasers for a specific discount rate are generated during an auction.

That is, in the case in which goods are provided as resources of a social auction, even when purchasers select a predetermined discount rate (for example, discount of 25%), one product needs to be sold at the corresponding discount rate, and therefore there is a need to perform processing to generate a discount rate subtraction of 100% when viewed from goods.

Further, the social auction service operating server 10 included in the event sale system using a social auction according to the embodiment of the present invention may also automatically inform reserved purchasers purchasing brand purchasing tickets issued by companies of social auction starting information, when a social auction starting condition of each company is satisfied and may only publicly announce the social auction starting information.

Further, the event sale system using a social auction according to the embodiment of the present invention allows sellers not to suggest a predetermined number of goods for promotion at a time, and newly suggests repeatedly a predetermined number of goods when goods are exhausted during a social auction to progress a social auction as if a social auction is progressed several times. In the case in which sellers provide goods for promotion, the social auction service operating server 10 determines whether non-suggested residual goods are present when successful bidding processing is performed by generating selection signals of reserved purchasers for a specific discount rate during an auction, and if it is determined that the non-suggested residual goods are present, may be previously established to progress an additional social auction.

Further, as described above, the event sale system using a social auction according to the embodiment of the present invention allows sellers to provide goods and brand purchasing tickets for promotion. During the auction, the social auction service operating server 10 preferentially processes the subtraction for goods when a successful bidder is generated, and when there is no residual goods, performs the successful bidding processing in order of the subtraction processing for an issuance resource of the brand purchasing tickets.

Therefore, the event sale system using a social auction according to the embodiment of the present invention performs the subtraction by 100% unit since the resource for goods is subtracted at a discount rate in the early stages of the social auction, and performs the subtraction for the accumulated discount rate (500%) obtained by substituting issuance money of the brand purchasing ticket into a discount rate, after the number (for example, five) of goods provided by sellers are subtracted at a discount rate (500%), and therefore freely performs the discount rate subtraction.

Meanwhile, the event sale system using a social auction according to the embodiment of the present invention may separately issue a goods non-designated brand purchasing ticket and a goods designated brand purchasing ticket when sellers issue brand purchasing tickets, in which the goods non-designated brand purchasing ticket may freely designate and purchase goods after an social auction is progressed, but the goods designated brand purchasing ticket previously designates goods to be purchased later before the social auction is progressed, such that the goods non-designated brand purchasing ticket is further added with a special issuance condition.

In the event sale system using a social auction according to the embodiment of the present invention, in the case of purchasing goods later using the goods non-designated brand purchasing ticket, the goods non-designated brand purchasing ticket may be used only when the goods price needs to be set a preset multiple as large as a face value of the goods non-designated brand purchasing ticket.

Therefore, the social auction service operation server 10 matches special conditions of the seller for the use of the corresponding purchasing tickets with a unique number of the corresponding purchasing tickets in the case of the goods non-designated brand purchasing ticket to perform processing to further store the special conditions.

The special conditions may be processed to interwork with the discount rate acquired by the purchasers, and when the discount rate acquired by the purchasers participating in a social auction by purchasing the goods non-designated brand purchasing ticket ranges from 1% to 30%, goods may be purchased in the case in which a goods price is two times as large as a face value of a purchasing ticket, and when the discount rate ranges from 31% to 50%, goods may be purchased in the case in which a goods price is three times as large as the face value of the purchasing ticket.

Meanwhile, the event sale system using a social auction according to the embodiment of the present invention may store the set conditions to change sale conditions set by sellers in response to an accumulated issuance number when the sellers issue the brand purchasing tickets, and monitor the issuance number to perform processing to automatically change the sale conditions.

That is, the social auction service operating server 10 may store the set conditions to change the sale conditions set by the purchasers in response to the accumulated issuance number when the brand purchasing tickets are issued, and monitor the issuance number to perform processing to automatically change the sale conditions.

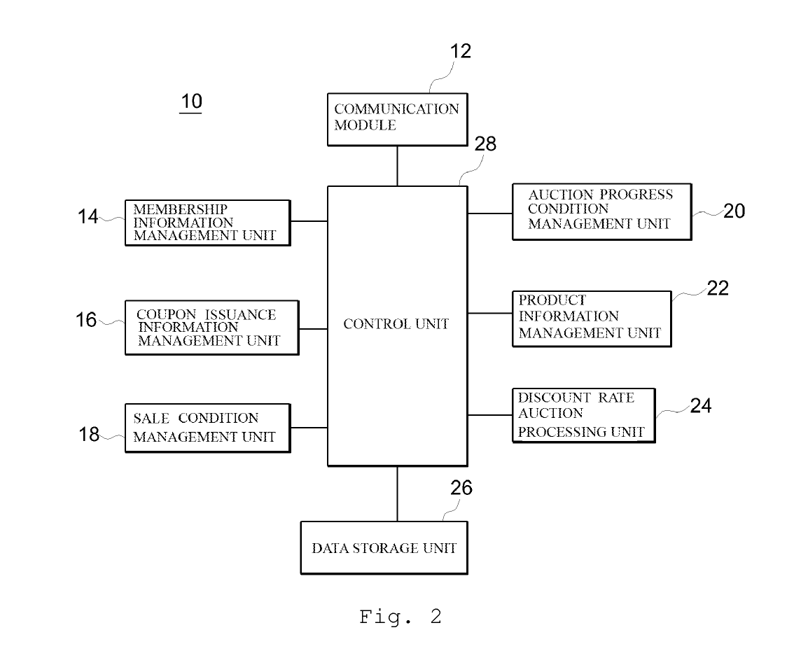

FIG. 2 is a block configuration diagram illustrating a configuration of a social auction service operating server included in an event sale system using a social auction according to a first embodiment of the present invention.

Referring to FIG. 2, the social auction service operating server 10 included in the event sale system using a social auction according to the embodiment of the present invention includes a communication module, a membership information management unit, a purchasing ticket issuance information management unit, a sale condition management unit, an auction progress condition management unit, a goods information management unit, a discount rate auction processing unit, a data storage unit, and a control unit.

The system according to the embodiment of the present invention further includes a means 12 which communicates with the purchaser terminal 2 and the seller terminal 4, and a membership information management unit 14 which is a means for managing personal information on purchasers and sellers.

The sale condition management unit 18 manages sale condition information uploaded by each seller. The sale condition management unit 18 may upload the sale conditions on goods and the issuance conditions on the purchasing tickets and the social auction service operating server 10 performs the sale processing according to the conditions set by the sellers during the social auction.

For example, when sellers limit the participating conditions of the social auction, the social auction service operating server 10 performs limited processing to make only the purchasers satisfying the corresponding conditions participate in the social auction of the corresponding brand.

The auction progress condition management unit 20 manages information set as conditions to allow the seller to progress the auction. The auction progress condition management unit 20 may manage the information set by the seller to start an auction, when a predetermined number of purchasers participate in the auction or a predetermined accumulated discount amount arrives.

The sale information management unit 22 manages sale information to be sold by a seller. The sale information management unit 22 may perform processing to change information on goods which may be purchased, interworking with the discount rate acquired by purchasers participating in the social auction using the goods non-designated brand purchasing ticket.

A social auction processing means 24 has an algorithm performing an auction. The algorithm, as a discount rate auction processing unit, automatically increases (for example, 0%, 2%, 4%, . . . , and 100%) a discount rate in a one-time auction, selects a purchaser first generating any one of bidding signals as a successful bidder in the auction of the corresponding time, and performs processing to provide a discount rate when the corresponding successful bidding signal is generated as a successful bidding discount rate to a successful bidder.

The system according to the embodiment of the present invention includes a means 26 which stores social auction information, purchaser information, seller information, product sale information, cost settlement information, and social auction resource information. The control unit 28 controls each management unit or processing unit to perform registration of information on each purchaser and seller, issuance of a brand purchasing ticket, social auction processing, and settlement of sale money.

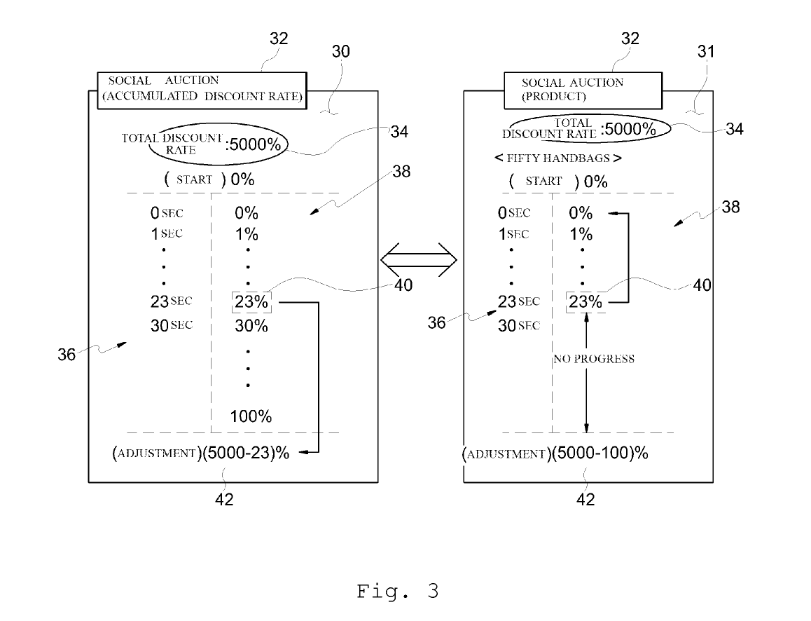

FIG. 3 is a diagram schematically illustrating an operating principle of the event sale system using a social auction according to the first embodiment of the present invention.

Referring to FIG. 3, the event sale system using a social auction according to the first embodiment of the present invention selects different discount rate subtraction methods corresponding to a formation type of resources during the social auction.

That is, the event sale system using a social auction according to the first embodiment of the present invention performs the discount rate subtraction at the time of differently performing the successful bidding processing of purchasers, when the resource of the social auction is an issuance amount of the brand purchasing ticket and is goods for promotion provided by sellers.

In more detail, in the event sale system using a social auction according to the first embodiment of the present invention, when sellers provide a predetermined number of specific goods for promotion, the social auction service operating server 10 included in the event sale system using a social auction according to the embodiment of the present invention performs processing to subtract a discount rate of 100% corresponding to a discount rate of one product, when discount selection signals of reserved purchasers for a specific discount rate are generated during an auction.

That is, in the case in which goods are provided as resources of a social auction, even when purchasers select a predetermined discount rate (for example, discount rate of 25%), one product needs to be sold at the corresponding discount rate, and therefore there is a need to perform processing to generate a discount rate subtraction of 100% when viewed from goods.

Total discount rate information 34 (for example, a total accumulated discount rate is 5,000% when the number of a handbag is 50) which may be arbitrarily selected by a plurality of purchasers participating in an auction window 31 in which a social auction using goods as a resource is progressed is published.

Further, when the auction starts, the discount rate which may be selected by purchasers is constantly increased from 0% for a predetermined time period 36, and when any one the purchasers generates the selection signal to the social auction service operating server 10 at a discount rate 40 when the discount rate is for example 23% in a discount rate display window 38, sellers sells one product to the corresponding purchaser. Therefore the subtraction of 100% is performed at the time of the subtraction of the accumulated discount rate.

Accordingly as unit subtraction state information, 4,900% obtained by subtracting a discount rate 100% from the total accumulated discount rate 5,000% per one product remains.

On the other hand, when the accumulated saved money is 5,000% by issuing the brand purchasing ticket, the subtraction for the accumulated discount rate in which the issuance money of the brand purchasing ticket is substituted into the discount rate is performed, and therefore the subtraction for the discount rate is freely performed, for example, 24%, 19% or the like.

That is, as illustrated in the left of FIG. 3, in the case in which any one of the purchasers generates the selection signal to the social auction service operating server 10 at a discount rate 40 when the discount rate is for example 23% in the discount rate display wind 38, 4,977% remains by subtracting the selected discount rate 23% from the total accumulated discount rate 5,000%.

Hereinafter, a function and an operation of the event sale system using a social auction according to the first embodiment of the present invention will be described in detail with reference to the accompanying drawings.

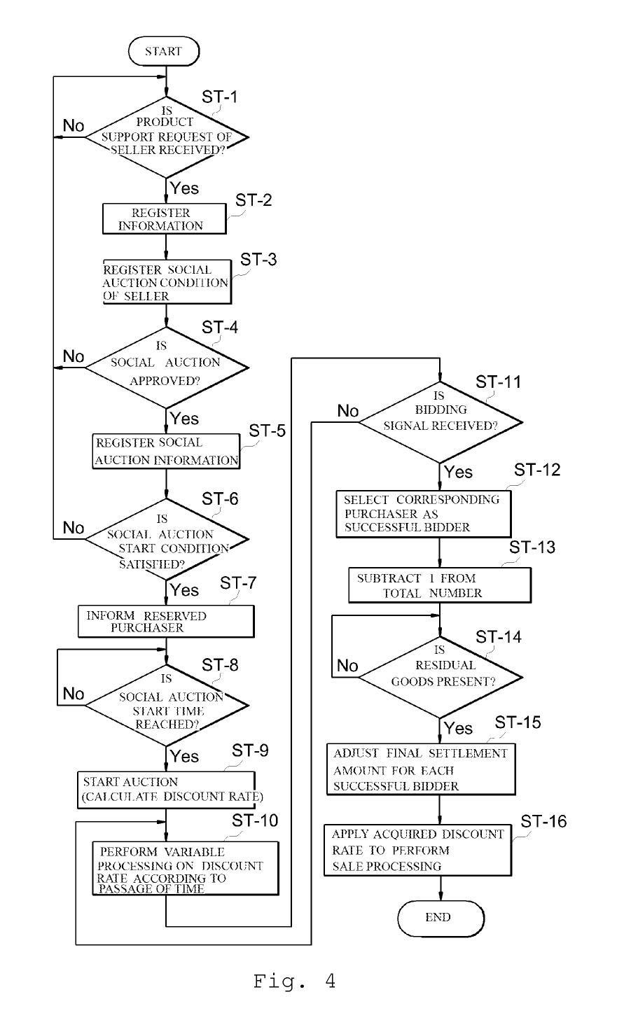

FIG. 4 is a flow chart illustrating a signal flow of the event sale system using a social auction according to the first embodiment of the present invention.

The event sale system using a social auction according to the first embodiment of the present invention performs the social auction processing even when sellers provide a predetermined number of specific goods for promotion.

First, the social auction service operation server 10 included in the event sale system using a social auction according to the first embodiment of the present invention determines whether a signal setting a predetermined number of goods for promotion is applied from the seller terminal 4.

When the signal setting the predetermined number of goods for promotion resources is applied from the seller terminal 4, the social auction service operating server 10 registers the corresponding information and registers the social auction conditions of the sellers.

In this case, the social auction does not use the issuance money of the brand purchasing ticket as a resource, and therefore purchasers who do not purchase the brand purchasing tickets, such that various purchasers may experience the social auction by the method.

When the social auction of the social auction service operating server 10 is approved, the social auction service operation server 10 registers the corresponding social auction information.

In this state, the social auction service operation server determines whether a predetermined number of purchasers participate in the social auction or the social auction starting conditions such as an arrival of an arbitrarily set social auction time are satisfied. If it is determined that the social auction starting conditions are satisfied, the social auction service operating server 10 may set a specific auction date to publicly announce the social auction, and may inform reserved purchasers indicating a participation opinion of the auction starting date information.

Further, the social auction service operating server 10 converts the corresponding promotion goods as the accumulated saved money. Herein, when the corresponding social auction starting time arrives, the social auction service operating server 10 performs the social auction.

That is, the social auction service operating server 10 performs variable processing to automatically increase the discount rate at the same ratio for a predetermined time period until the preset accumulated discount rate is completely exhausted.

In this state, the social auction service operating server 10 receives the selection signal for the specific discount rate from the reserved purchaser terminal 2 to process the corresponding selected purchaser as a successful bidder and subtracts 100% regardless of the discount rate selected by the reserved purchasers.

The reason of subtracting 100% is that the resource of the social auction suggested as the promotion by the seller is goods.

After the subtraction, the social auction service operating server 10 determines whether the residual accumulated saved money is present. That is, the social auction service operation server 10 determines whether the residual goods are present.

When the residual goods are present, the social auction service operating server 10 continuously performs the social auction, while when the residual goods are not present, the social auction service operating server 10 performs settlement processing on a final settlement amount of each successful bidder and performs settlement processing of the corresponding purchaser.

That is, money to be settled by the purchaser is a final price that the corresponding discount rate is reflected to a goods price.

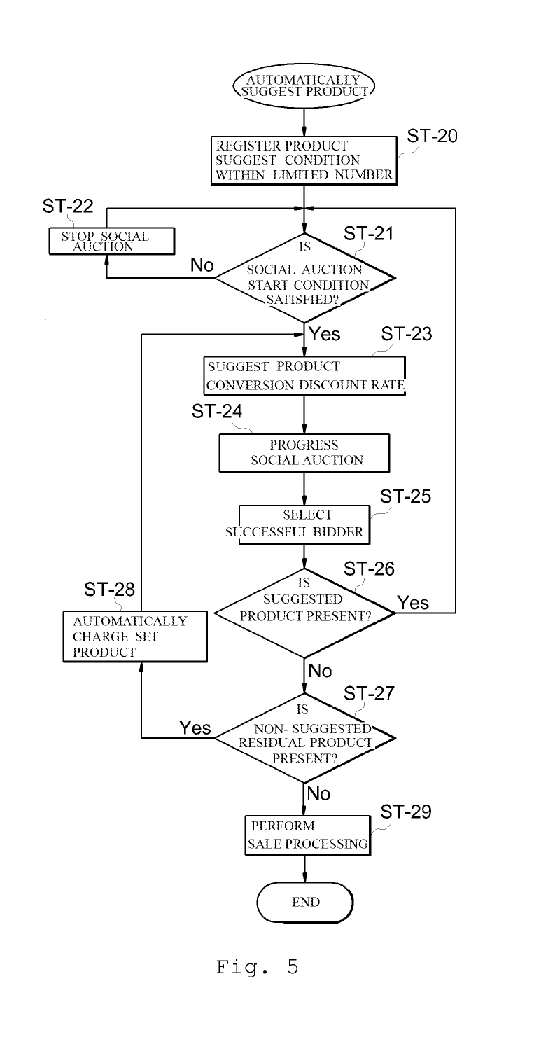

FIG. 5 is a flow chart illustrating a signal flow for an automatic product suggest of the event sale system using a social auction according to a first embodiment of the present invention.

The social auction service operating server 10 included in the event sale system using a social auction according to the first embodiment of the present invention may charge and provide goods as many as the number of divided units every time the goods provided to the social auction are completely exhausted by being divided in a predetermined unit by the setting of the seller.

Therefore, the event sale system using a social auction according to the first embodiment of the present invention may have an effect of progressing the social auction several times while performing a one-time social auction, and make a seller continuously keep a purchaser's interest.

To this end, the social auction service operating server 10 determines whether the signal setting a predetermined number of goods as the promotion resource is applied from the seller terminal 4, and registers the goods suggest conditions at the time of progressing the social auction of the seller.

That is, a goods unit is suggested by 20 at the time of progressing the social auction and when the suggested goods are completely exhausted, sellers may be set in the social auction service operating server 10 so as to provide a total 60 goods as the resource of the social auction by a method for additionally providing 20 goods again.

In this state, when the setting is made, the social auction service operation server 10 determines whether a predetermined number of purchasers participate in the social auction or the social auction starting conditions such as an arrival of an arbitrarily set social auction time are satisfied and if it is determined that the social auction starting conditions are satisfied, the social auction service operating server 10 may set a specific auction date to publicly announce the social auction, and may inform reserved purchasers indicating a participation opinion of the auction starting date information.

Further, the social auction service operating server 10 preferentially suggests, as the resource of the social auction, the number of goods in a predetermined unit suggested as the conditions by a seller among the corresponding promotion goods, and converts the number of goods as the accumulated saved money and the social auction service operating server 10 progresses the social auction.

That is, the social auction service operating server 10 performs variable processing to automatically increase the discount rate at the same ratio for a predetermined time period until the preset accumulated discount rate is completely exhausted.

In this state, the social auction service operating server 10 receives the selection signal for the specific discount rate from the reserved purchaser terminal 2 to process the corresponding selected purchaser as a successful bidder, and subtracts 100% regardless of the discount rate selected by the reserved purchasers.

The reason of subtracting 100% is that the resource of the social auction suggested as the promotion by the seller is goods.

After the subtraction, the social auction service operation server 10 determines whether the residual goods are present.

When the residual goods are present, the social auction service operating server 10 progresses the social auction until goods are completely exhausted, while filling goods in the same unit as the resource of the social auction.

When the residual goods are not present, the social auction service operating server 10 settles the final settlement amount of each successful bidder and performs the settlement processing of the corresponding purchaser.

Hereinafter, a function and an operation of the event sale system using a social auction according to a second embodiment of the present invention will be described in detail with reference to the accompanying drawings.

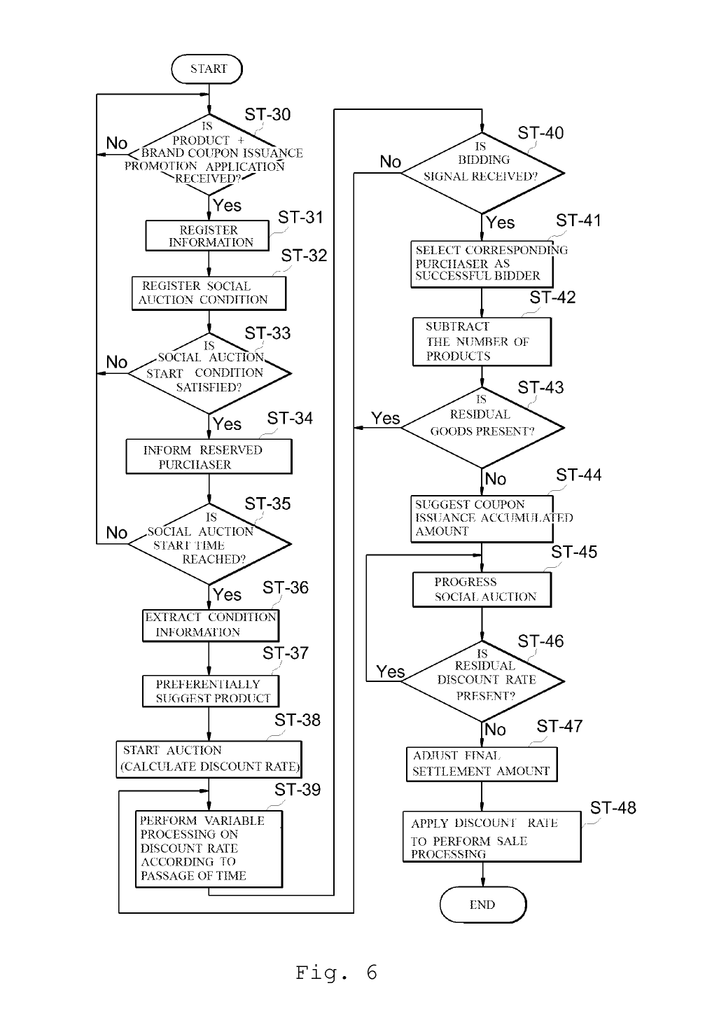

FIG. 6 is a flow chart illustrating a signal flow for a social auction using, as resources, a product and accumulated saved money of an event sale system using a social auction according to a second embodiment of the present invention.

Referring to FIG. 6, as described above, the event sale system using a social auction according to the embodiment of the present invention allows sellers to provide goods and brand purchasing tickets for promotion. During the auction, the social auction service operating server 10 preferentially processes the subtraction process of goods when a successful bidder is generated, and when there is no residual goods, performs the successful bidding processing in order of the subtraction processing for the issuance resources of the brand purchasing ticket.

Therefore, the event sale system using a social auction according to the embodiment of the present invention performs the subtraction by 100% unit since the resource for goods is subtracted at a discount rate in the early stages of the social auction, and performs the subtraction for the accumulated discount rate (500%) obtained by substituting the issuance money of the brand purchasing ticket into a discount rate, after the number (for example, five) of goods provided by sellers are subtracted at a discount rate (500%). Therefore, the subtraction for the discount rate is freely performed, for example, 24%, 19% or the like.

In more detail, the social auction service operating server 10 determines whether a seller receives an application signal providing goods and an issuance resource of a brand purchasing ticket for promotion.

When the request signal providing goods and the issuance resource of the brand purchasing ticket as the promotion is received, the social auction service operating server 10 registers the corresponding information and registers the social auction conditions set by a seller.

In this state, when the auction starting conditions are satisfied and thus the auction is progressed, the social auction service operating server 10 preferentially performs the subtraction for the promotion goods.

That is, the social auction service operating server 10 converts the corresponding promotion goods and the issuance money of the brand purchasing ticket as the accumulated saved money. When the corresponding social auction starting time arrives, the social auction service operating server 10 performs the social auction.

In other words, the social auction service operating server 10 performs variable processing to automatically increase the discount rate at the same ratio for a predetermined time period until the preset accumulated discount rate is completely exhausted.

In this state, the social auction service operating server 10 receives the selection signal for the specific discount rate from the reserved purchaser terminal 2 to process the corresponding selected purchaser as a successful bidder, and subtracts 100% regardless of the discount rate selected by the reserved purchasers.

The reason of subtracting 100% is that the resource of the social auction suggested as the promotion by the seller is goods.

After the subtraction, the social auction service operation server 10 determines whether the residual goods are present. When the residual goods are present, the social auction service operating server 10 continuously progresses the social auction.

When the residual goods are not present, all the promotion goods are sold. Therefore the social auction is progressed using the accumulated discount rate into which the issuance money of the brand purchasing ticket is converted as the resource.

The social auction service operating server 10 receives the selection signal for the specific discount rate from the reserved purchaser terminal 2 to process the corresponding selected purchaser as a successful bidder, allows the reserved purchaser to perform the subtraction processing on the selected discount rate, and determines whether the residual accumulated discount rate is present after the subtraction.

When the accumulated discount rate is not present, the corresponding social auction is completed, and the final settlement money to which the successfully bid discount rate is reflected is settled to perform the settlement processing.

Hereinafter, a function and an operation of the event sale system using a social auction according to a third embodiment of the present invention will be described in detail with reference to the accompanying drawings.

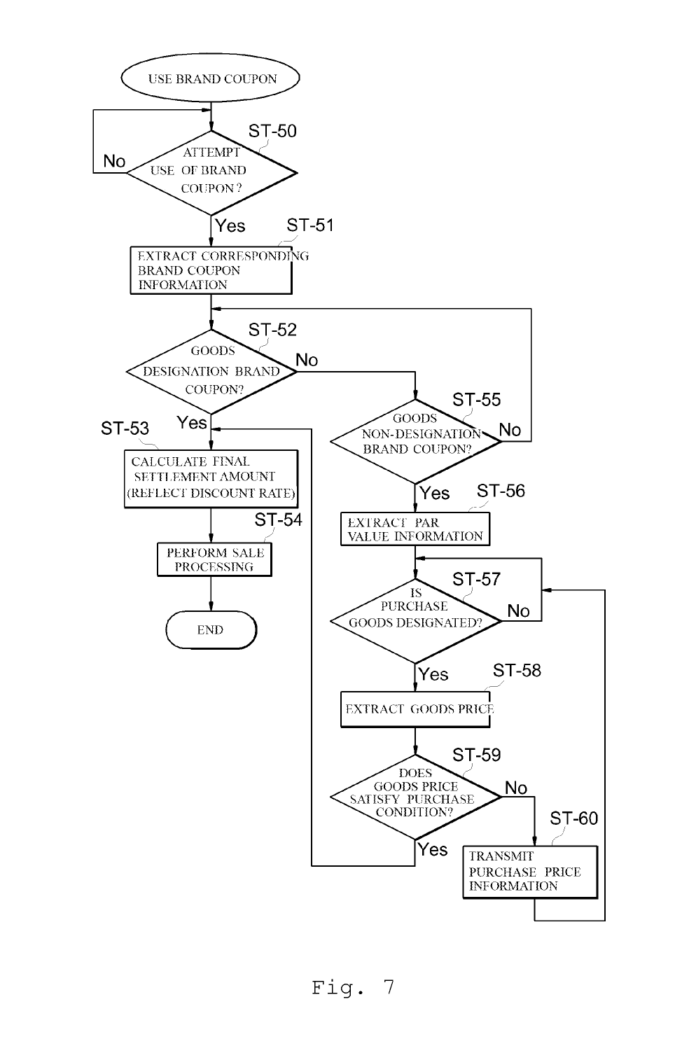

FIG. 7 is a flow chart illustrating a signal flow for a brand purchasing ticket use of an event sale system using a social auction according to a third embodiment of the present invention.

First, the event sale system using a social auction according to the third embodiment of the present invention may separately issue a goods non-designated brand purchasing ticket and a goods designated brand purchasing ticket when sellers issue brand purchasing tickets, in which the goods non-designated brand purchasing ticket may freely designate and purchase goods after an social auction is progressed. However, the goods designated brand purchasing ticket previously designates goods to be purchased later before the social auction is progressed, such that the goods non-designated brand purchasing ticket is further added with a special issuance condition.

In the event sale system using a social auction according to the embodiment of the present invention, in the case of purchasing goods later using the goods non-designated brand purchasing ticket, the goods non-designated brand purchasing ticket may be used only when the goods price needs to be set a preset multiple as large as a face value of the goods non-designated brand purchasing ticket.

In more detail, when the social auction is completed to allow any one of the purchasers to apply the use attempt signal to a specific brand goods ticket, the social auction service operating server 10 extracts the corresponding brand information and determines whether the corresponding brand purchasing ticket is the goods designated brand purchasing ticket or the goods non-designated brand purchasing ticket.

When the corresponding brand purchasing ticket is the goods designated brand purchasing ticket, the social auction service operating server 10 reflects the discount rate selected and acquired by the corresponding purchaser to calculate the final settlement amount, and perform the sale processing to immediately use the corresponding brand purchasing ticket.

On the other hand, when the corresponding brand purchasing ticket is the goods non-designated brand purchasing ticket, the social auction service operating server 10 extracts the condition information matched with the corresponding goods non-designated brand purchasing ticket in advance. For example, when only goods having a value several times as large as a face value may be purchased, the social auction service operating server 10 extracts the purchasable goods information to determine whether the suggested purchase signal is received, thereby performing the sale processing.

When the purchase signal for goods other than the suggested goods is accepted, the social auction service operating server 10 may request to settle additional penalty cost or inform sale impossible information.

Nevertheless, since the goods non-designated brand purchasing ticket does not set the purchase for specific goods in advance, goods may be freely selected for a predetermined time, which may be attractive to a purchaser despite additional conditions.

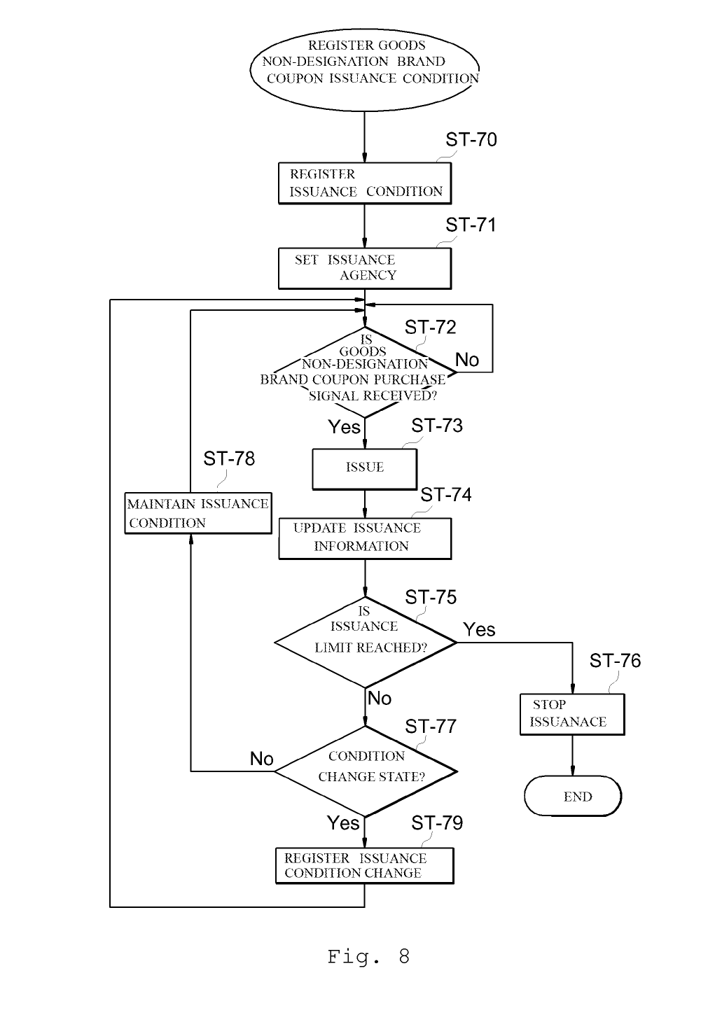

FIG. 8 is a flow chart illustrating a signal flow for registration of goods non-designated brand purchasing ticket of the event sale system using a social auction according to the third embodiment of the present invention.

First, the event sale system using a social auction according to the third embodiment of the present invention may separately issue a goods non-designated brand purchasing ticket and a goods designated brand purchasing ticket when sellers issue brand purchasing tickets, in which the goods non-designated brand purchasing ticket may freely designate and purchase goods after an social auction is progressed. However the goods designated brand purchasing ticket previously designates goods to be purchased later before the social auction is progressed. Therefore the goods non-designated brand purchasing ticket is further added with a special issuance condition, such that a seller may give the conditions at the time of issuing the brand purchasing ticket.

First, a seller may store the set conditions in the social auction service operating server 10 so as to change the sale conditions set by the seller corresponding to the accumulated issuance number at the time of issuing the brand purchasing ticket.

Therefore, the social auction service operating server 10 monitors the issuance number of the brand purchasing ticket issued by the corresponding seller, and automatically changes the sale conditions by reflecting the preset sale conditions of the corresponding seller.

When it is determined that the corresponding brand purchasing ticket exceeds a preset issuance limit value by monitoring the social auction service operating server 10, the social auction service operating server 10 stops the issuance.

Hereinafter, a function and an operation of the event sale system using a social auction according to a fourth embodiment of the present invention will be described in detail with reference to the accompanying drawings.

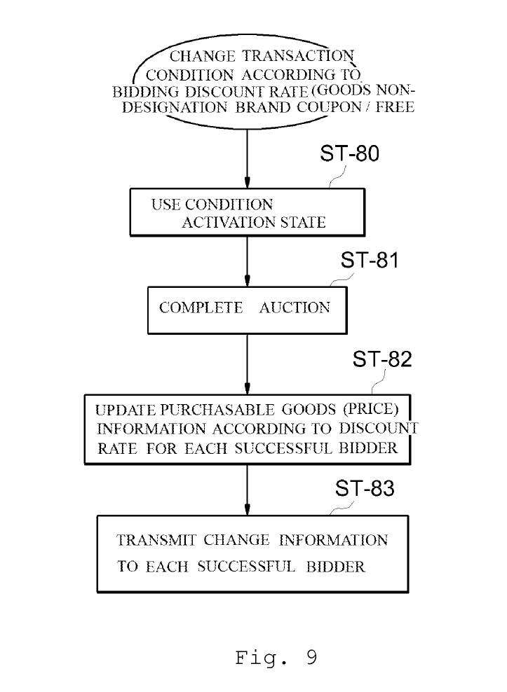

FIG. 9 is a flow chart of a signal flow for a fluctuation of bidding discount rate interworking transaction conditions of an event sale system using a social auction according to a fourth embodiment of the present invention.

First, the event sale system using a social auction according to a fourth embodiment of the present invention may give additional benefits to a purchaser which does not acquire a great discount rate.

The additional benefits according to the embodiment of the present invention is to compensate for the case in which the discount rate acquired by a purchaser purchasing the goods non-designated brand purchasing ticket is small, and when the goods non-designated brand purchasing ticket is issued, adds use condition information to the social auction service operating server 10 to be shared with a purchaser and a seller.

Then, the social auction service operating server 10 registers the corresponding information and after the social auction is progressed, purchases the goods non-designated brand purchasing ticket to extract goods information corresponding to the case in which a goods price is two times as large as a face value of the purchasing ticket as a preset condition, when the discount rate acquired by the purchasers participating in the social auction ranges from 1% to 30%, and may purchase goods.

Further, the social auction service operating server 10 may purchase the goods non-designated brand purchasing ticket, and may purchase goods having a value three times as large as a face value of the purchasing ticket when the discount rate acquired by purchasers participating in the social auction ranges from 31% to 50%.

That is, the social auction service operating server 10 allows a seller to fluctuate the purchasable goods information, interworking with the successful bidding discount rate

Hereinafter, a function and an operation of the event sale system using a social auction according to a fifth embodiment of the present invention will be described in detail with reference to the accompanying drawings.

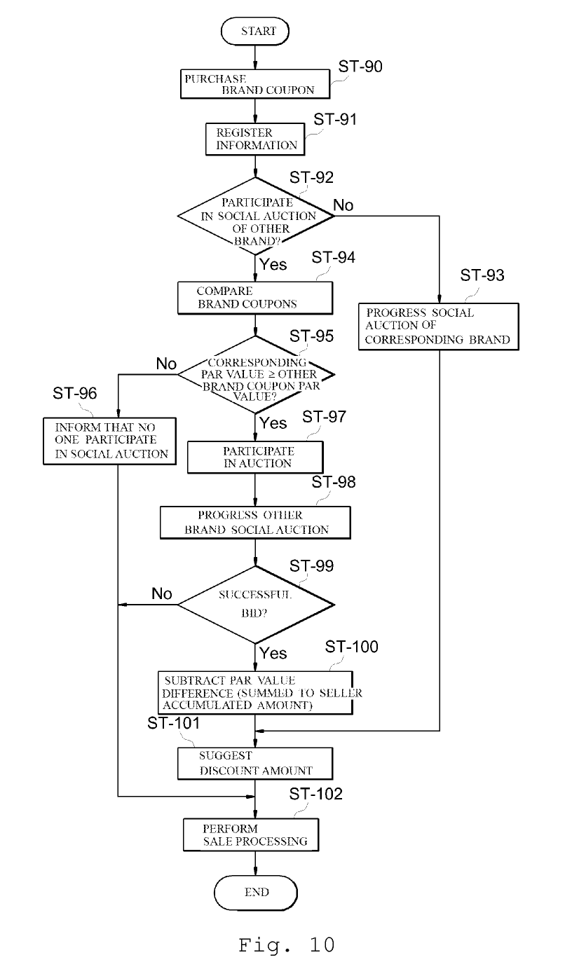

FIG. 10 is a flow chart illustrating a signal flow for a brand purchasing ticket cross use of an event sale system using a social auction according to a fifth embodiment of the present invention.

First, the event sale system using a social auction according to the fifth embodiment of the present invention is built to participate in a social auction of other brands using the brand purchasing ticket. In addition, when the reserved purchasers participating in the social auction of other brands are present using the brand purchasing ticket, the social auction service operating server 10 may perform processing to allow the reserved purchasers to participate in an social auction using the brand purchasing ticket only when the corresponding brand purchasing ticket has an issuance face value higher than that of the brand purchasing tickets of other brand companies.

That is, in the event sale system using a social auction according to the fifth embodiment of the present invention, when a purchaser purchases a specific brand purchasing ticket and the information is registered in the social auction service operating server 10, the social auction service operating server 10 determines whether a desired participating signal is applied to another brand social auction.

When the desired participating signal is applied to another brand social auction, the social auction service operating server 10 compares two brand purchasing tickets to determine whether a face value of the corresponding brand purchasing ticket is larger than or equal to that of another brand purchasing ticket to participate.

When the face value of the corresponding brand purchasing ticket is larger than or equal to that of another brand purchasing ticket to participate, the social auction service operating server 10 performs auction participating possible processing.

On the other hand, when the face value of the corresponding brand purchasing ticket is not larger than or different from that of another brand purchasing ticket to participate, the social auction service operating server 10 informs the corresponding purchaser of auction participating impossible information.

Meanwhile, when the face value of the brand purchasing ticket is used by participating in another brand social auction, the social auction service operating server 10 performs processing to include the corresponding difference in the accumulated saved money resource of another brand social auction in the case in which the difference of the face value is present.

Further, the sale processing is performed by applying the discount rate acquired to be equal to another social auction.

Hereinafter, a function and an operation of the event sale system using a social auction according to a sixth embodiment of the present invention will be described in detail with reference to the accompanying drawings.

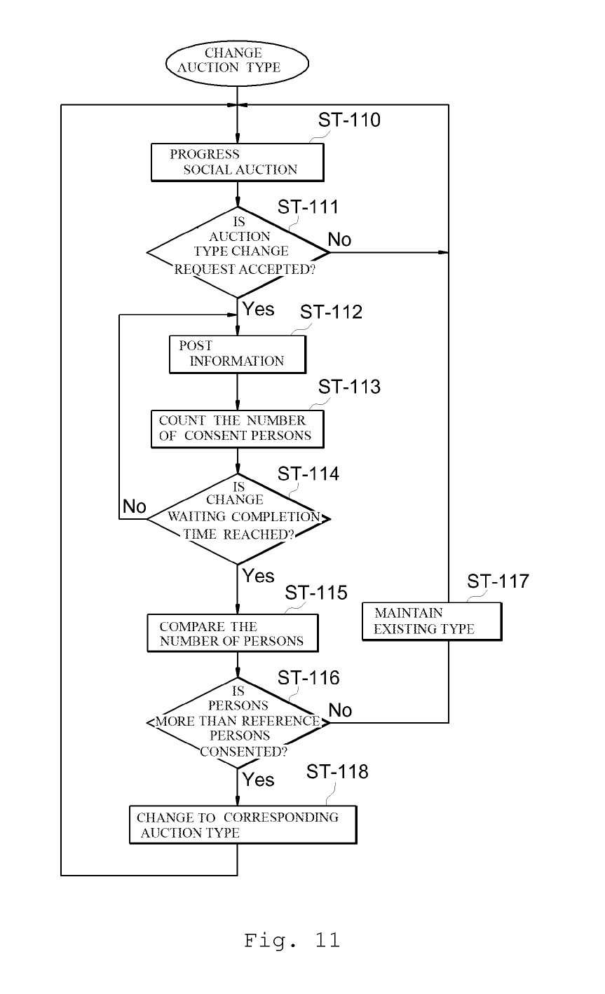

FIG. 11 is a flow chart illustrating a signal flow for a change in an auction based on swarm intelligence of an event sale system using a social auction according to a sixth embodiment of the present invention.

Referring to FIG. 11, the event sale system using a social auction according to the sixth embodiment of the present invention may perform processing to change an auction method at the time of a consent of a predetermined ratio of participating purchasers in the case in which the accumulated discount rate into which the promotion resource is converted is smaller than a set value. Further, the social auction service operating server 10 may perform processing to change the auction type at the time of the consent of the predetermined ratio of participating purchaser in the case in which the accumulated discount rate into which the promotion resource is converted is smaller than the set value.

First, in the event sale system using a social auction according to the sixth embodiment of the present invention, the social auction service operating server 10 determines whether the auction type change request signal is accepted during the social auction.

When the auction type change request signal is accepted from any one of the purchaser terminals 2, the social auction service operating server 10 determines whether the condition is an auction type changeable condition.

That is, the changeable condition depends on one previously known by social auction service operating server 10. According to the embodiment of the present invention, for example, the auction type changeable condition depends on whether the residual accumulated saved money is equal to or less than a predetermined value.

In other words, when the residual accumulated saved money is equal to or less than a predetermined value, the change requesting conditions are basically satisfied.

In this state, when the condition may be changed, the social auction service operating server 10 obtains consent by publicly announcing the auction type change to the corresponding auction participants and determines whether a consent signal of a predetermined ratio of participating purchasers is accepted to perform the change processing of the auction type.

According to the embodiment of the present invention, it may be specific game and may be lot by changing the auction type.

Hereinafter, an event sale system using a social auction according to a seventh embodiment of the present invention will be described in detail.

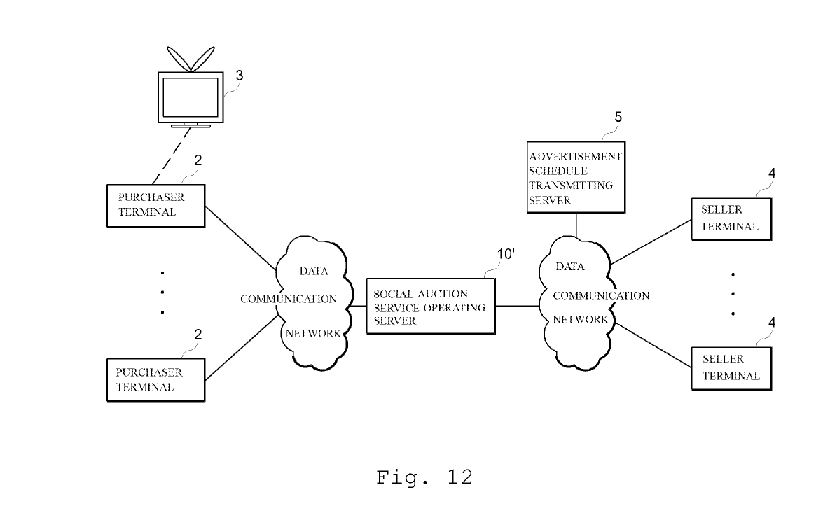

FIG. 12 is a diagram illustrating a schematic configuration of an event sale system using a social auction according to a seventh embodiment of the present invention, and

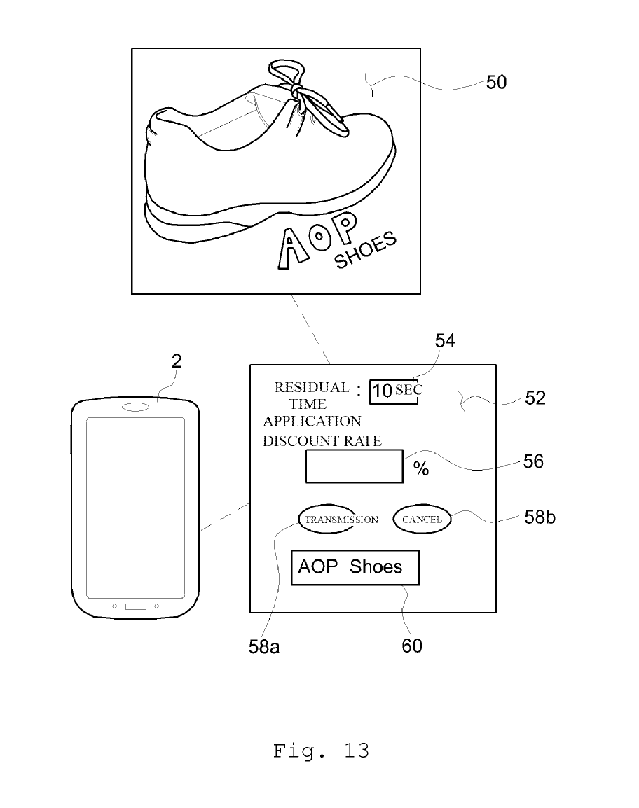

FIG. 13 is a diagram illustrating an information output state of a TV interworking social auction using the event sale system using a social auction according to the seventh embodiment of the present invention.

Referring to the drawings, the event sale system using a social auction according to the seventh embodiment of the present invention is a system which accepts social auction participating signals of purchasers for goods output through the corresponding advertisement, interworking with advertisement output through TV, and pays a purchase support money of the corresponding goods to a number of selected purchasers to maximizes an advertising effect.

The event sale system using a social auction according to the seventh embodiment of the present invention includes the purchaser terminal 2 which purchases a brand purchasing ticket for participating in an auction supported with a discount rate using a future purchase of goods as security, and generates an auction participating signal.

Further, the event sale system using a social auction according to the seventh embodiment of the present invention includes a seller terminal 4 which performs an issuance request to issue the brand purchasing tickets securing a future sale to purchasers, registration of sale goods information, and registration of sale conditions and generates a signal providing a predetermined number of goods to be used as promotion resources.

Meanwhile, the event sale system using a social auction according to the seventh embodiment of the present invention includes a social auction service operating server 10′ which sets, as an event resource, a predetermined number of specific goods matched with goods output through the TV advertisement or the corresponding goods to progress a TV advertisement interworking social auction service for a period at which the corresponding TV advertisement is output.

That is, the event sale system using a social auction according to the seventh embodiment of the present invention allows sellers progressing the goods advertisement of their own companies to more increase the advertising concentration of purchasers through the TV advertisement and progresses the social auction for a period at which the TV advertisement is progressed to activate a sale and goods progressed in the social auction may be advertising goods output through the corresponding TV advertisement or may be specific goods arbitrarily designated by the corresponding seller.

In this case, the fact that the TV advertisement interworking social auction service is progressed by the event sale system using a social auction according to the seventh embodiment of the present invention may not yet be recognized by a purchaser, and therefore the social auction service operating server 10′ transmits the information on the TV advertisement interworking social auction service to social auction applications equipped in the purchaser terminal 2.

To this end, the social auction service operating server 10′ may also use a broadcasting scheduler program which may extract broadcasting program information and directly receive the broadcasting scheduler information from an advertising schedule transmission server 5 which is equipped in a broadcasting station or related companies.

Further, the information on the TV advertisement interworking social auction service provided from the social auction service operating server 10′ to the purchaser terminal 2 side is auction goods information matched with the remaining time of the auction service participation and the corresponding TV advertisement.

Therefore, a number of unspecific purchasers receives the information on the TV advertisement interworking social auction service from the social auction service operating server 10 to view the corresponding TV advertisement, and therefore shows higher advertising concentration and may effectively sell a large amount of goods for very short time at the time of outputting the corresponding advertisement as if goods are sold through the home shopping.

Meanwhile, the social auction service operating server 10′ accepts the requested discount information from the purchaser terminal 2 from the starting of the TV advertisement interworking social auction service until the auction participating remaining time arrives

In more detail, the social auction service operating server 10′ may transmit a large amount of information interworking with the TV advertisement to the purchaser terminal 2 and a purchaser drives applications which are equipped in the purchaser terminal 2, and outputs an input screen 52 participating in the social auction when selecting any one of goods screens 50 matched with the TV advertisement.

The input screen 52 is maintained for a period at which the corresponding TV advertisement is output and another TV advertisement interworking social auction in which the TV advertisement of another seller is progressed may be progressed.

Remaining time information 54 is displayed on the input screen 52, a requested discount rate information input window 56 to be input by purchasers is output, a transmission button 58a and a cancel button 58b are output, and goods information 60 is displayed on a lower portion thereof.

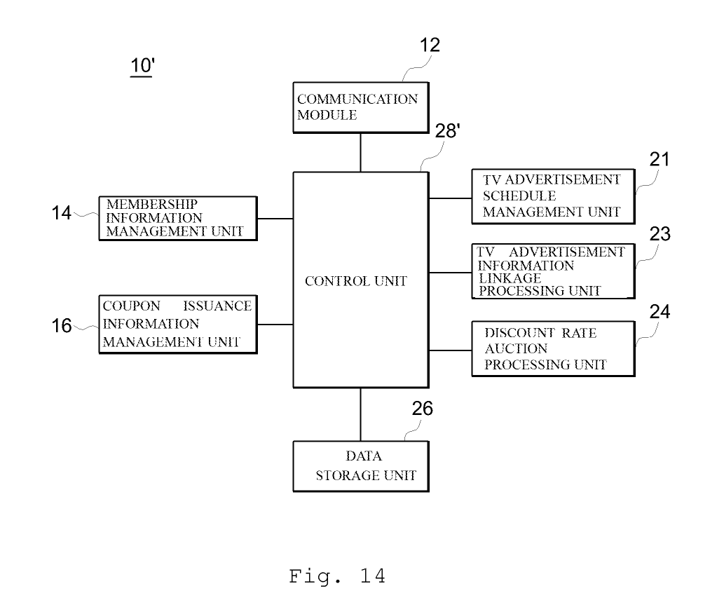

FIG. 14 is a block configuration diagram illustrating a configuration of a social auction service operating server included in the event sale system using a social auction according to the seventh embodiment of the present invention.

Referring to FIG. 14, the social auction service operating server 10′ included in the social auction service operating server included in the event sale system using a social auction according to the seventh embodiment of the present invention includes the communication module 12 which communicates with the purchaser terminal 2 and the seller terminal 4, the membership information management unit 14 which manages personal information on purchasers and sellers, the purchasing ticket issuance information management unit 16 which manages the purchasing ticket issuance information, and a TV advertisement schedule management unit 21 which manages the TV advertising schedule information to progress the social auction matched with the TV advertisement.

Further, the social auction service operating server 10′ includes a TV advertisement information interworking processing unit 23 which processes goods information interworking with TV advertisement, promotion information of the corresponding goods, and auction time information to progress the social auction matched with the TV advertisement, a discount rate auction processing unit 24 which accepts the requested discount rate of a plurality of purchasers and performs the subtraction processing on the purchasing support money by subtracting requested discount rate from the accumulated promotion cost, a data storage unit 26 which stores the purchasing ticket issuance information, the goods information interworking with the TV advertisement to progress the social auction matched with the TV advertisement, the promotion information of the corresponding goods, the auction time information, and the auction result information, and a control unit 28′ which transmits the social auction information progressed interworking with the TV advertisement to the purchaser terminal 2 to accept the auction participation and processes the social auction to perform a control to inform the goods information of the seller progressing the TV advertisement.

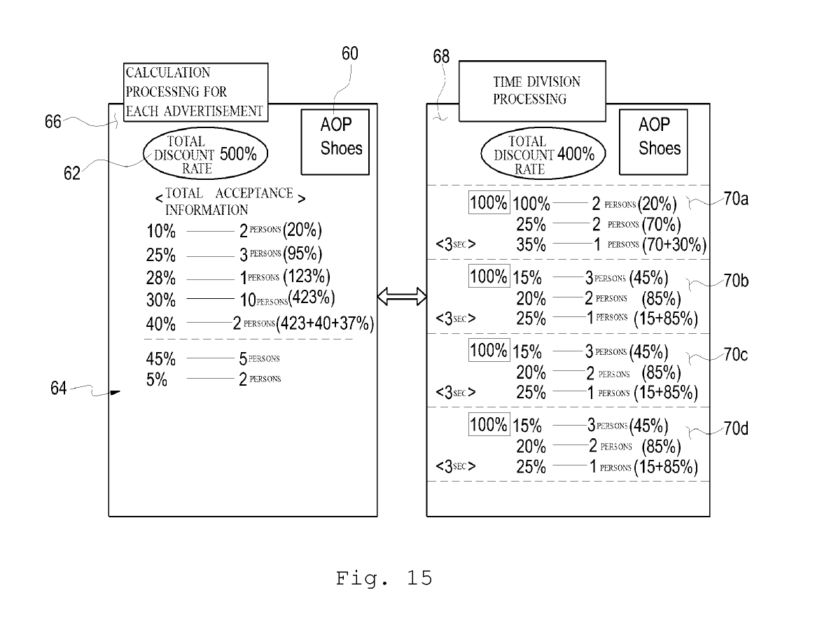

FIG. 15 is a diagram illustrating a state of processing a TV interworking social auction in real time using the event sale system using a social auction according to the seventh embodiment of the present invention.

Referring to FIG. 15, when the TV advertisement interworking social auction is processed using the event sale system using a social auction according to the seventh embodiment of the present invention, the social auction may be progressed for the period at which the corresponding TV advertisement is progressed, for example, about 15 seconds and may be processed by two methods.

The first method is a method for constantly setting discount rate acceptance time (about 12 seconds) of a purchaser in the total advertisement time (for example, 15 sec) and setting the remaining time to be a result announcement time (about 3 sec) to progress a one-time social auction.

This may be described with reference to a screen 66 illustrated in the left of FIG. 15 and first, the goods information 60 is displayed on the corresponding screen, the total discount rate information 62 (500%: represents that five corresponding goods are provided for promotion with the same concept as the accumulated purchase support money) is displayed thereon, and the requested discount rate information 64 requested by purchasers are displayed thereon.

When the total discount rate provided as promotion is 500%, a purchaser requesting 10% to 40% may receive the purchase support money.

The second method is a method for dividing a total 15 seconds by 3 seconds to progress the social auction five times and in this case, divides the purchase support money for supporting purchasers into ⅕ to be supported for each section.

This may be described with reference to a screen 68 illustrated in the right of FIG. 15 and first, the goods information 60 is displayed on the corresponding screen, the total discount rate information (400%: represents that four corresponding goods are provided for promotion with the same concept as the accumulated purchase support money) is displayed thereon, and the requested discount rate information 64 requested by purchasers are displayed thereon at each section 70a, 70b, . . . which are divided into multi sections. That is, the time is divided, and thus the social auction may be progressed at the multi sections.

When the total discount rate provided as promotion is 500%, a purchaser requesting 10% to 40% may receive the purchase support money.

Therefore, the TV advertisement interworking social auction service accepts the social auction for specific goods set by a seller of the corresponding TV advertisement for a period at which the specific TV advertisement is output and is set in the social auction service operating server 10′ to select the predetermined number of purchasers which receive the purchase support money.

Further, the TV advertisement interworking social auction service may divide the time when the specific TV advertisement is output into the multi sections, accept the social auction for specific goods set by a seller of the corresponding TV advertisement at each section, and may be set in the social auction service operating server 10′ to select the predetermined number of purchasers which receive the purchase support money.

Further, the accumulated promotion cost set in the corresponding goods is processed by the social auction service operating sever 10′ to be equally divided at each section.

Hereinafter, an event sale system using a social auction according to an eighth embodiment of the present invention will be described in detail.

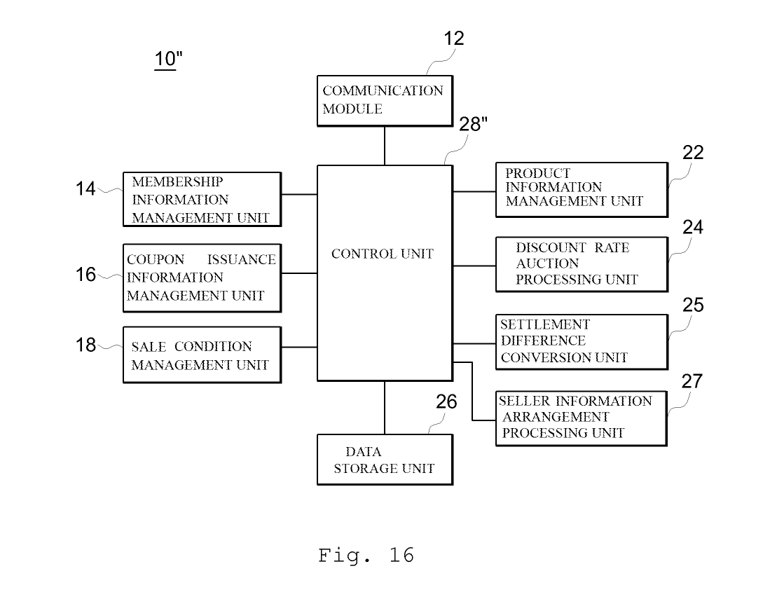

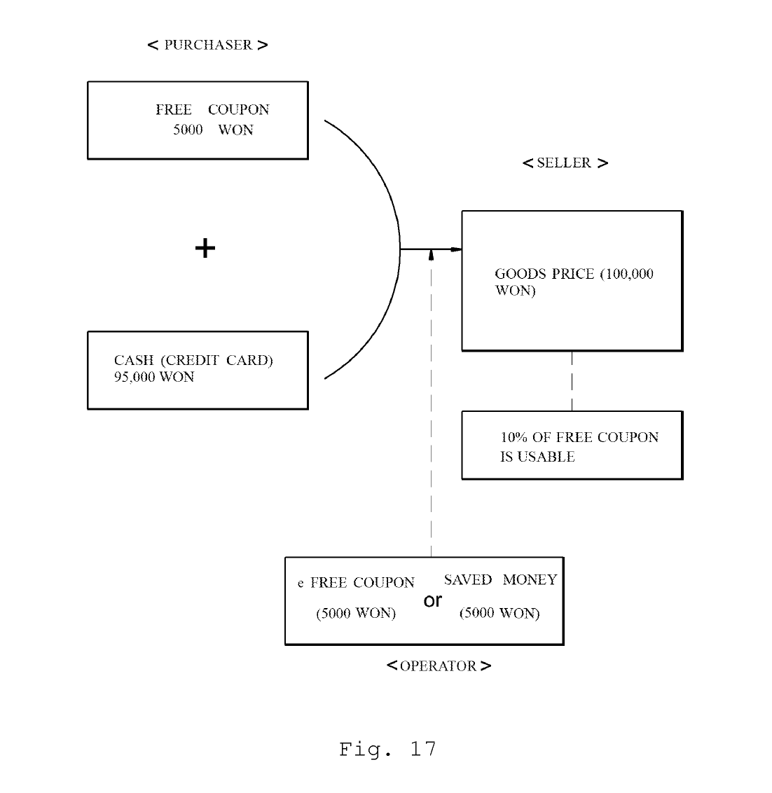

FIG. 16 is a block configuration diagram illustrating a configuration of a social auction service operating server performing purchasing ticket settlement difference conversion processing using an event sale system using a social auction according to an eighth embodiment of the present invention, and FIG. 17 is a diagram illustrating the purchasing ticket settlement difference conversion processing state using an event sale system using a social auction according to the eighth embodiment of the present invention.

Referring to the drawings, the event sale system using a social auction according to the eighth embodiment of the present invention is a system which since an equivalent value of the free purchasing ticket owned by a purchaser is smaller than a use amount of the free purchasing ticket permitted to the specific goods, when the difference is settled in cash or credit card, provides a right to participate in a social auction using the difference or convert the difference into saved money.

A social auction service operating server 10″ performing the purchasing ticket settlement difference conversion processing using the event sale system using a social auction according to the eighth embodiment of the present invention performs processing to provide a right to participate in a social auction using the difference or convert the difference into saved money when the difference is settled in cash or credit card since an equivalent value of the free purchasing ticket owned by a purchaser is smaller than a use amount of the free purchasing ticket permitted to the specific goods.

In this case, the free purchasing ticket is a purchasing ticket to allow the purchaser to receive the discount service of an amount corresponding to a free purchasing ticket selling amount by a promise of sellers.

Meanwhile, the social auction service operating server 10″ includes the membership information management unit 14 which manages the information on sellers and purchasers, the purchasing ticket issuance information management unit 16 which manages the purchasing ticket issuance information, the sale condition management unit 18 which manages the sale condition information uploaded by each seller, a goods information management unit 22 which manages sale information to be sold by sellers, a discount rate auction processing unit 24 which accepts the requested discount rate of a plurality of purchasers and performs subtraction processing on the purchase support money by subtracting from the accumulated promotion cost, a settlement difference conversion unit 25 which converts the difference settled in cash or credit card into the social auction participating ticket or the saved money since the equivalent value of the free purchasing ticket owned by purchasers is smaller than the use amount of the free purchasing ticket permitted to the specific goods, the data storage unit 26 which manages the issuance information on the free purchasing ticket, stores the available amount information of the free purchasing tickets for each seller, stores the cash settlement difference information at the time of using the free purchasing ticket, and stores compensation information on the difference, and a control unit 28″ which performs a control to manage the issuance information on the free purchasing ticket, manage the available amount information on the free purchasing tickets for each seller, and convert the cash settlement difference at the time of using the free purchasing ticket.

In this case, the social auction service operating server 10″ further includes a seller information arrangement unit 27 which arranges the seller information in order of a large available amount permitting the use of the free purchasing ticket having a larger equivalent value, arranges the seller information in order of a large event amount in the seller information holding special event information, or arranges the seller information included in a specific area to be read by the purchaser terminal.

Therefore, by the event sale system using a social auction according to the eighth embodiment of the present invention, when a purchaser purchases goods having an equivalent value of 100,000 won with a free purchasing ticket having an equivalent value of 5,000 won, in the case in which the corresponding goods has a condition to permit only the free purchasing ticket of 10%, a purchaser needs to perform the free purchasing ticket having an equivalent value of 5,000 won and cash settlement of 5,000 won.

That is, cash 5,000 won does not participate in the social auction, and therefore the event sale system using a social auction according to the eighth embodiment of the present invention may provide a right to participate in the social auction using cash 5,000 won or may convert it into saved money corresponding to 5,000 won to be discounted later and provide the saved money to the corresponding purchaser.

According to the embodiments of the present invention, the event sale system using a social auction and a method thereof may allow sellers to sell division purchasing tickets to secure a future sale, thereby easily securing the production capital, effectively promoting and selling goods, and providing the planned production and the effective promotion and sale, may assign various appropriate conditions to each seller to effectively perform the promotion, may allow purchasers to preferentially pay a portion of goods sale money so as to purchase the division purchasing ticket, thereby securing the right to participate in the social auction, may allow purchasers to challenge the accumulated discount rate winning based on the right to enjoy the possibility of economic benefits, and may unspecific purchasers to receive information on the TV advertisement interworking social auction service from the social auction service operating server so as to view the corresponding TV advertisement, thereby making the purchasers more concentrate on the advertisement and effectively selling lots of goods for a very short time at the time of the output of the corresponding advertisement as if goods are sold through the home shopping.

Meanwhile, the event sale system using a social auction and the method thereof according to the embodiment of the present invention are not limited to the above embodiments but may be variously changed without departing from the technical subjects thereof.

1. An event sale system using a social auction, comprising:
a purchaser terminal configured to purchase a brand purchasing ticket for participating in an auction supported with a discount rate using a future purchase of goods as security, and generate an auction participating signal;
a seller terminal configured to perform an issuance request issuing the brand purchasing ticket securing a future sale to a purchaser, registration of sale goods information, and registration of sale conditions, and generate a signal providing a predetermined number of goods to be used as promotion resources; and
a social auction service operating server configured to sell the brand purchasing tickets issued to each seller as a social auction participating condition, register purchaser information, and perform auction processing using sale cost of the brand purchasing ticket and goods for promotion as resources.

2. The event sale system of claim 1, wherein the social auction automatically increases a discount rate for a predetermined time period from an auction starting time until a preset accumulated discount rate is completely exhausted, and reserved purchasers select a specific discount rate on their own, and thus a plurality of purchasers are selected as a support recipient and receive support money corresponding to a discount rate.

3. The event sale system of claim 1, wherein the brand purchasing ticket includes:
a goods designated brand purchasing ticket promising a future purchase of specific goods of a specific brand; and
a goods non-designated brand purchasing ticket promising a future purchase of the specific brand but not promising a purchase of specific goods.

4. The event sale system of claim 1, wherein the social auction service operating server performs processing to subtract a discount rate of 100% corresponding to a discount rate of one goods, when a selection signal of reserved purchasers for a specific discount rate is generated at the time of progressing an auction in the case in which a seller provides goods for promotion.

5. The event sale system of claim 1, wherein the social auction service operating server automatically informs reserved purchasers purchasing brand purchasing ticket issued by corresponding companies of social auction starting information, when social auction starting conditions of each company are satisfied.

6. The event sale system of claim 1, wherein the social auction service operating server determines whether non-suggested residual goods are present, when successful bidding processing is made by generating a selection signal of reserved purchasers for a specific discount rate at the time of progressing an auction in the case in which a purchaser provides goods for promotion, and if it is determined that the non-suggested residual goods are present, performs an additional social auction.

7. The event sale system of claim 1, wherein the social auction service operating server preferentially processes subtraction processing on goods when a successful bidder is generated due to the progress of the auction in the case in which a seller provides goods and issuance resources of the brand purchasing tickets for promotion, and when residual goods are not present, performs successful bidding processing in order of subtraction processing on the issuance resources of the brand purchasing ticket.

8. The event sale system of claim 1, wherein the social auction service operating server further stores a special condition of a seller for the use of the corresponding purchasing ticket matched with a unique number of the corresponding purchasing ticket in the case of the goods non-designated brand purchasing ticket.

9. The event sale system of claim 1, wherein the social auction service operating server stores a set condition to change a sale condition set by the seller corresponding to an accumulated issuance number at the time of issuing the brand purchasing ticket and monitors the issuance number to automatically change the sale condition.

10. The event sale system of claim 1, wherein the social auction service operating server stores a set condition of a purchaser to automatically change purchasable goods depending on a successful bidding discount rate when a social auction is completed and automatically changes the set condition.

11. The event sale system of claim 1, wherein the social auction service operating server performs processing to participate in an auction only in the case in which the corresponding brand purchasing ticket has a higher issuance face value than that of brand purchasing tickets of other brand companies by using the brand purchasing ticket, when a reserved purchaser participating in the social auction of other brands is present.

12. The event sale system of claim 1, wherein the social auction service operating server performs processing to change an auction type at the time of consent of a predetermined ratio of participating purchasers when an accumulated discount rate into which the promotion resources are converted is smaller than a set value.

13. The event sale system of claim 1, wherein the social auction service operating server sets a predetermined number of specific goods matched with goods output through TV advertisement or specific goods matched with the corresponding goods as an event resource to progress a TV advertisement interworking social auction service for a period at which the corresponding TV advertisement is output.

14. The event sale system of claim 13, wherein the social auction service operating server transmits a residual time of auction service participation and goods information to be auctioned matched with the corresponding TV advertisement as information on the TV advertisement interworking social auction service.

15. The event sale system of claim 13, wherein the social auction service operating server accepts requested discount rate information from the purchaser terminal from starting of the TV advertisement interworking social auction service until auction participating residual time arrives.

16. The event sale system of claim 13, wherein the social auction service operating server include:
a communication module configured to communicate with the purchaser terminal and the seller terminal;
a membership information management unit configured to manage personal information on a purchaser and a seller;
a purchasing ticket issuance information management unit configured to manage purchasing ticket issuance information;
a TV advertisement schedule management unit configured to manage TV advertising schedule information to progress a social auction matched with the TV advertisement;
a TV advertisement information interworking processing unit configured to process goods information interworking with the TV advertisement, promotion information of the corresponding goods, and auction time information to progress the social auction matched with the TV advertisement;
a discount rate auction processing unit configured to accept the requested discount rate of a plurality of purchasers, and perform subtraction processing on purchasing support money by subtracting the requested discount rate from accumulated promotion cost;
a data storage unit configured to store purchasing ticket issuance information, goods information interworking with the TV advertisement to progress the social auction matched with the TV advertisement, promotion information of the corresponding goods, auction time information, and auction result information; and
a control unit configured to transmit the social auction information progressed interworking with the TV advertisement to the purchaser terminal to accept auction participation, and process the social auction to perform a control for informing the goods information of the seller progressing the TV advertisement.

17. The event sale system of claim 13, wherein the TV advertisement interworking social auction service accepts the social auction for specific goods set by a seller of the corresponding TV advertisement for a period at which the specific TV advertisement is output, and is set in the social auction service operating server to select the predetermined number of purchasers which receive the purchase support money.

18. The event sale system of claim 13, wherein the TV advertisement interworking social auction service divides the time when the specific TV advertisement is output into multi sections, accepts the social auction for specific goods set by a seller of the corresponding TV advertisement at each section, and is set in the social auction service operating server to select the predetermined number of purchasers which receive the purchase support money at each section.

19. The event sale system of claim 18, wherein accumulated promotion cost set in the corresponding goods is processed by the social auction service operating sever to be equally divided at each section

20. The event sale system of claim 1, wherein since an equivalent value of a free purchasing ticket owned by a purchaser is smaller than a use amount of the free purchasing ticket permitted to specific goods, when the difference is settled in cash or credit card, the social auction service operating server provides a right to participate in a social auction using the difference or convert the difference into saved money.

21. The event sale system of claim 20, wherein the free purchasing ticket allows the purchaser to receive a discount service of an amount corresponding to a free purchasing ticket selling amount by an engagement of sellers.

22. The event sale system of claim 20, wherein the social auction service operating server includes:
a membership information management unit configured to manage information on a seller and a purchaser;
a purchasing ticket issuance information management unit configured to manage purchasing ticket issuance information;
a sale condition management unit configured to manage sale condition information uploaded by each seller;
a goods information management unit configured to manage sale information to be sold by the seller;
a discount rate auction processing unit configured to accept a requested discount rate of a plurality of purchasers and performing subtraction processing on purchasing support money by subtracting the requested discount rate from accumulated promotion cost;
a settlement difference conversion unit configured to convert a difference settled in cash or credit card into a social auction participating ticket or saved money since an equivalent value of the free purchasing ticket owned by the purchaser is smaller than a use amount of a free purchasing ticket permitted to specific goods;
a data storage unit configured to store issuance information on the free purchasing ticket, and available amount information of the free purchasing tickets for each seller, and store cash settlement difference information at the time of using the free purchasing ticket, and compensation information on the difference; and
a control unit configured to perform a control to manage the issuance information on the free purchasing ticket, manage the available amount information on the free purchasing tickets for each seller, and convert the cash settlement difference at the time of using the free purchasing ticket.

23. The event sale system of claim 22, wherein the social auction service operating server further includes a seller information arrangement unit configured to arrange the seller information in order of a large available amount permitting the use of the free purchasing ticket having a larger equivalent value, arrange the seller information in order of a large event amount in the seller information holding special event information, or arrange the seller information included in a specific area to be read by the purchaser terminal.

24. An event sale method using a social auction, comprising:
a first process of setting, by a social auction service operating server, a predetermined number of goods as promotion resources from a seller terminal;
a second process of converting the corresponding promotion goods into accumulated saved money;
a third process of determining, the social auction service operating server, whether a social auction condition is satisfied;
a fourth process of performing processing to automatically increase a discount rate at the same ratio at a predetermined period from starting of an auction until a preset accumulated discount rate is completely exhausted;
a fifth process of processing a corresponding selected purchaser as a successful bidder by receiving a selection signal for a specific discount rate from a reserved purchaser terminal;
a sixth process of subtracting 100% regardless of the selected discount rate;
a seventh process of determining whether a residual accumulated saved money is present;
an eighth process of settling a final settlement amount of each successful bidder; and
a ninth process of performing settlement processing.

25. The event sale method of claim 24, wherein the third process further includes informing all the reserved purchasers that all the reserved purchasers participate in the social auction without condition.

26. The event sale method of claim 24, wherein the fourth process includes:
dividing a total accumulated saved money several times;
monitoring whether the accumulated saved money is completely exhausted due to the progress of the auction; and
additionally suggesting the divided accumulated save money every time the accumulated saved money is completely exhausted.

27. The event sale method of claim 24, wherein, when the promotion resources suggested by the seller in the first process are goods and a brand purchasing ticket issuance income, subtraction of the accumulated saved money for goods is preferentially processed at the time of processing the successful bidding, and when the accumulated saved money for goods is completely exhausted, the subtraction processing is performed in subtraction order of the accumulated saved money into which the brand purchasing ticket issuance income is converted.

28. The event sale method of claim 24, wherein the ninth process further includes determining whether the settlement of the purchaser satisfies a special condition of the seller for the use of the corresponding purchasing ticket, when the brand purchasing ticket purchased by the purchaser is a goods non-designated brand purchasing ticket at the time of settlement.

29. The event sale method of claim 24, further comprising:
prior to the first process, storing a set condition to change a sale condition set by the seller in response to the accumulated issuance number at the time of issuing the brand purchasing ticket;
monitoring the issuance number of the brand purchasing ticket issued by the corresponding seller; and
automatically changing the sale condition by reflecting the preset sale condition of the corresponding seller.

30. The event sale method of claim 24, wherein the eighth process further includes:
determining whether purchasable goods information depending on the successful bidding discount rate is present when the social auction is completed; and
when the purchasable goods depending on the corresponding successful bidding discount rate are present, suggesting purchasable information by being automatically changed to the corresponding goods information.

31. An event sale method using a social auction, comprising:
a first process of providing a social auction resource to a social auction service operating server due to an issuance of a brand purchasing ticket of a seller;
a second process of determining whether a desired participating signal is applied to another brand social auction;
a third process of determining whether a face value of the corresponding brand purchasing ticket is equal to or larger than that of another brand purchasing ticket to participate;
a fourth process of performing auction participating possible processing when a face value of the corresponding brand purchasing ticket is equal to or larger than that of another brand purchasing ticket to participate; and
a fifth process of performing processing to include a corresponding difference in an accumulated saved money resource when the face value difference is present.

32. An event sale method using a social auction, comprising:
a first process of determining, by a social auction service operating server, whether an auction type changing request signal is accepted during a progress of the social auction;
a second process of determining, by the social auction service operating server, whether there is a condition to change the auction type;
if it is determined that the auction type is changed, a third process of publicly announcing, by the social auction service operating server, the auction type change to a corresponding auction participant; and
a fourth process of performing processing to change the auction type at the time of consent of a predetermined ratio of participating purchasers.

33. The event sale method of claim 32, wherein the condition to change the auction type in the second process is on whether the residual accumulated saved money is equal to or less than a predetermined amount.
